(19) United States
(12) Patent Application Publication
(10) Pub. No.: US 2007/0115953 A1
(43) Pub. Date: May 24, 2007

(54) VOICE-RECORDING APPARATUS AND VOICE-BAND AUDIO CODEC

(76) Inventors: Hsuan-Fan Chen, Taipei City (TW); Chung Pei Tsai, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,895

(22) Filed: Jan. 16, 2006

(30) Foreign Application Priority Data
Nov. 7, 2005 (TW) 94138933

(51) Int. Cl. H04L 12/50

(52) U.S. Cl. 370/359

(57) ABSTRACT

A voice-recording apparatus and a voice-band audio CODEC apparatus derived therefrom are disclosed. The voice-recording apparatus includes a multiplexer, a successive approximation analog-to-digital converter (SAR-ADC); and a pulse code modulation code digital circuit (PCM code digital circuit). The multiplexer alternately outputs a left channel input signal and a right channel input signal in response to a first clock signal. The SAR-ADC is coupled to the multiplexer, takes a second clock signal as the operating frequency thereof and converts the left channel input signal and the right channel input signal from analog signal format into digital signal format. The PCM code digital circuit converts the output signal of the SAR-ADC from serial digital code into parallel digital code.

### CROSS-REFERENCE TO RELATED APPLICATION

This application claims the priority benefit of Taiwan application serial no. 94138933, filed on Nov. 7, 2005. All disclosure of the Taiwan application is incorporated herein by reference.

### BACKGROUND OF THE INVENTION

1. Field of Invention

The present invention relates to a voice-recording apparatus and a voice-band audio CODEC (coder-decoder) apparatus, and particularly to a voice recording apparatus and a voice-band audio CODEC apparatus employing a successive approximation analog-to-digital converter (SAR-ADC).

2. Description of the Related Art

The delta-sigma approach (Δ-Σ approach) has been broadly used in audio products today, such as DVD player (digital versatile disc player), MP3 player, portable music player, bluetooth headphone, USB speaker (universal serial bus speaker), voice over Internet protocol (VoIP), etc. As to the great successful applications with the Δ-Σ approach, it is contributed mainly by high resolution and better sound quality provided by a Δ-Σ ADC (analog-to-digital converter using delta-sigma architecture) and a Δ-Σ DAC (digital-to-analog converter using delta-sigma architecture).

However, audio products has various applications. For the applications only concerning on the voice recording level in requirement of the voice recording quality, the applications can be the voice recoding in various goods, such as voice-recording pen, voice-recording toy, monitor voice-recording and the general low-level MP3 player. For the consumer goods only requiring the voice-recording quality, they are implemented with a usual voice recording circuit. Even though the performance can be surely achieved by this manner, this manner also causes the additional power-consumption and the increase of chip area. In fact, such a circuit mostly employs the Δ-Σ architecture, and for a stereo recording result, the circuit must employ two Δ-Σ ADCs. Therefore, if merely the voice-recording is needed, for example, the circuit is used in low-level cases, such as human-voice recording and usual voice dictation, the circuit causes many disadvantages, such as larger power-consumption, shorter durable time of the employed battery and larger circuit area with extra added fabrication cost. In short, if a high-resolution Δ-Σ ADC is used to implement a low-level voice-recording product, it appears to waste the efficiency and be not worth.

### SUMMARY OF THE INVENTION

An object of the present invention is to provide a voice-recording apparatus, which meets the requirement of stereo voice-recording quality and is superior in a lower power-consumption and smaller chip area than the prior art.

Another object of the present invention is to provide a voice-band audio CODEC apparatus, which meets the requirement of stereo voice-recording quality and is superior in a lower power-consumption and smaller chip area than the prior art.

To achieve the above-described and other objects, the present invention provides a voice-band audio CODEC apparatus, which includes a multiplexer, a successive approximation analog-to-digital converter (SAR-ADC), a pulse code modulation (PCM) code digital circuit, a first delta-sigma digital-to-analog converter (Δ-Σ DAC) and a second Δ-Σ DAC.

Wherein, the multiplexer outputs a left channel input signal and a right channel input signal in response to a first clock signal. The SAR-ADC is coupled to the multiplexer, takes a second clock signal as the operating frequency thereof and converts the left channel input signal and the right channel input signal (both are analog signals) into the corresponding digital signals. The PCM code digital circuit converts the output signal from the SAR-ADC in serial digital codes into the corresponding signal in parallel digital codes during recording. The PCM code digital circuit further through an oversampling digital filter performs a filtering and a oversampling processing on the parallel digital codes and then separates into a left channel digital data and a right channel digital data during playback. The first Δ-Σ DAC and the second Δ-Σ DAC take a third clock signal as the operating frequency thereof and convert the digital signals of left/right channel digital data output from the PCM code digital circuit into corresponding analog signals, respectively.

In an embodiment, the above-described voice-band audio CODEC apparatus further includes a programmable gain amplifier (PGA) for amplifying the output signal from the multiplexer and providing the amplified signal to the SAR-ADC.

In an embodiment, the above-described voice-band audio CODEC apparatus further includes a clock signal generator for generating the above-mentioned first clock signal, second clock signal and third clock signal in response to a fourth clock signal.

In an embodiment, the above-described voice-band audio CODEC apparatus further includes a first low pass filter (LPF) and a second LPF for filtering high-frequency noises in the output signals from the first (Δ-Σ DAC) and the second (Δ-Σ DAC), respectively.

In an embodiment, the above-described voice-band audio CODEC apparatus further includes a headphone amplifier for amplifying the output signals from the first LPF and the second LPF. The filtered output signals are received by a headphone for listening.

On the other hand, the present invention provides a voice-recording apparatus, which essentially is the pre-stage audio recording circuit of the above-described voice-band audio CODEC apparatus, and it is omitted to describe for simplicity.

In comparison with a delta-sigma analog-to-digital converter (Δ-Σ ADC), a SAR-ADC has a lower resolution, however it is good enough for a low-frequency product, such as a voice-recording product, wherein the major advantage of a SAR-ADC is a faster sampling rate than a Δ-Σ ADC, a smaller circuit area and a lower power-consumption. Therefore, when a SAR-ADC with an appropriate resolution is used in audio products requiring a voice-recording quality, it not only meets the requirements of voice-recording, the goal and the quality thereof, but also gets significant efficiency improvements in terms of circuit area and power-consumption. Indeed, the SAR-ADC provides an excellent audio application solution for low-level voice recording.

In both the voice-recording apparatus and the voice-band audio CODEC apparatus provided by the present invention, only a single SAR-ADC is employed to achieve the stereo voice-recording function, which further reduces the power-consumption and downsizes the chip area in comparison with the conventional stereo voice-recording art in which two Δ-Σ ADCs are used.

In addition, the above-described PGA can be integrated into the voice-recording apparatus or the pre-stage audio recording circuit of the voice-band audio CODEC apparatus provided by the present invention for saving fabrication cost. Furthermore, the above-described headphone amplifier can be integrated into the post-stage playback circuit of the voice-band audio CODEC apparatus. In this way, the output from the voice-band audio CODEC apparatus is able to directly drive a headphone with low-impedance without an external amplifier component for further saving cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic circuit architecture drawing of a voice-band audio CODEC according to an embodiment of the present invention.

FIG. 2 is a clocking diagram showing audio-recording operation of the voice-band audio CODEC in FIG. 1.

### DESCRIPTION OF THE EMBODIMENTS

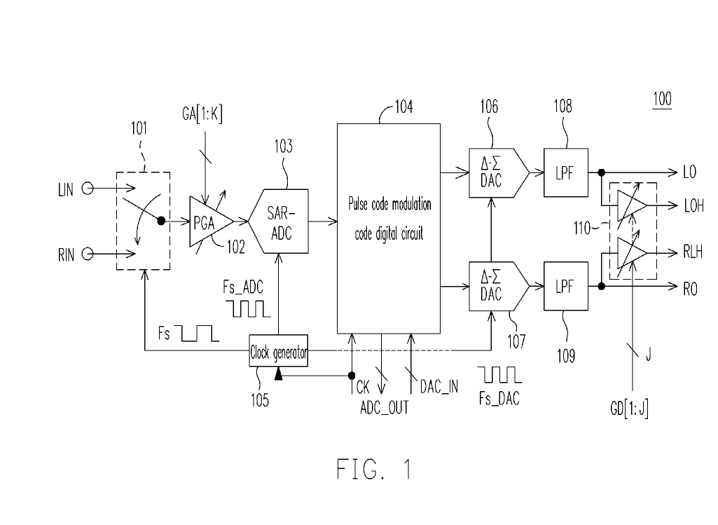

FIG. 1 is a schematic circuit architecture drawing of a voice-band audio CODEC 100 according to an embodiment of the present invention. The voice-band audio CODEC 100 includes a multiplexer 101, a programmable gain amplifier (PGA) 102, a successive approximation analog-to-digital converter (SAR-ADC) 103, a pulse code modulation (PCM) code digital circuit 104, two delta-sigma digital-to-analog converters (Δ-Σ DACs) 106 and 107, two low pass filters (LPFs) 108 and 109, a headphone amplifier 110 and a clock signal generator 105. The voice-band audio CODEC 100 has a voice-recording function and an audio playback function.

In recording, the multiplexer 101 receives a left channel input signal LIN and a right channel input signal RIN first and then alternately outputs the left channel input signal LIN and the right channel input signal RIN in response to a clock signal Fs. In the embodiment, when the clock signal Fs is at logic-0, the multiplexer 101 outputs the left channel input signal LIN, while the clock signal Fs is at logic-1, the multiplexer 101 outputs the right channel input signal RIN. In other embodiments of the present invention, however, an inverse mode is also allowed, that is when the clock signal Fs is at logic-1, the multiplexer 101 outputs the left channel input signal LIN, while the clock signal Fs is at logic-0, the multiplexer 101 outputs the right channel input signal RIN. The clock signal Fs defines the audio sampling rate (for example, 8 kHz or 48 kHz).

The PGA 102 adjusts the volume of recording signals, i.e. PGA 102 amplifies the output signals from the multiplexer 101 and provides the amplified signals to the SAR-ADC 103 for use. The adjustment gain of the PGA 102 is set by a signal GA[1:K].

Afterwards, the SAR-ADC 103 takes a clock signal Fs_ADC as the operating signal thereof and converts the left channel input signal LIN and the right channel input signal RIN of the PGA 102 from analog signals into digital signals.

Finally, the PCM code digital circuit 104 converts the output signal of the SAR-ADC 103 from serial digital code into parallel digital code ADC_OUT, which can be provided to an external circuit or a device for further processing or to directly storing.

According to the architecture, the multiplexer 101 can alternately switching in response to the clock signal Fs, so that the SAR-ADC 103 is able to sample and output digital code signals according to the frequency of the clock signal Fs. If the frequency of the clock signal Fs is 8 kHz, the left channel input signal LIN and the right channel input signal RIN are recorded in the sampling rate of 8 kHz. If the frequency of the clock signal Fs is 48 kHz, the left channel input signal LIN and the right channel input signal RIN are recorded in the sampling rate of 48 kHz. In this way, the goal of using a single SAR-ADC to complete a stereo voice-recording is achieved.

Note that the frequency relation between the clock signal Fs and the clock signal Fs_ADC (sampling rate) is governed by an inequation, that is (the frequency of Fs_ADC)>2*(frequency of Fs)*N. Wherein, N denotes the cycle number of the clock signal required for processing a piece of data in an individual sampling duration (i.e. the sampling number or the sampling amount). Thus, the SAR-ADC 103 needs N cycles of the clock signal Fs_ADC to complete converting a piece of data. For example, if the frequency of the clock signal Fs is 48 kHz and N=15, then, the frequency of the clock signal Fs_ADC must be at least 1.44 MHz.

If it is not needed to adjust volume in recording, the PGA 102 can be saved and the multiplexer 101 would directly output the signals to the SAR-ADC 103.

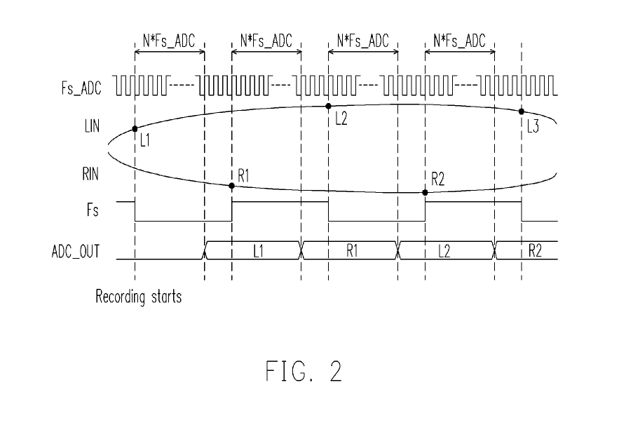

FIG. 2 is a clocking diagram showing audio-recording operation of the voice-band audio CODEC 100. Referring to FIG. 2, as recording starts, the clock signal Fs changes to logic-0, the data L1 of the left channel input signal LIN is sampled by the SAR-ADC 103. After a time of N cycles of the clock signal Fs_ADC, parallel digital code ADC_OUT of the data L1 are output from the PCM code digital circuit 104. Afterwards, the clock signal Fs is changed to logic-1, the data R1 of the right channel input signal RIN is sampled by the SAR-ADC 103. After a time of N cycles of the clock signal Fs_ADC, parallel digital code ADC_OUT of the data R1 are output from the PCM code digital circuit 104. Likewise, subsequent sampling is performed

To meet the requirement of audio playback, the voice-band audio CODEC apparatus 100 employs two Δ-Σ DACs 106 and 107. In playback, the PCM code digital circuit 104 uses an oversampling digital filter to perform a filtering on parallel digital code signal DAC_IN provided by an external circuit or an external device, followed by oversampling processing the filtered DAC_IN. At this time, a digital data of the left channel and a digital data of the right channel are separated. Then, the Δ-Σ DACs 106 and 107 take the clock signal Fs_DAC as the operating frequency thereof and convert the digital data of the left channel and the digital data of the right channel output from the PCM code digital circuit 104 from digital signal into the corresponding analog signals.

Further, the LPFs 108 and 109 filter high-frequency noises likely produced by the operations of the Δ-Σ DACs 106 and 107, respectively, and produce a left channel line-out signal LO and a right channel line-out signal RO. In the end, the headphone amplifier 110 amplifies the output signals from LPFs 108 and 109 and outputs a left channel headphone-out signal LOH and a right channel headphone-out signal ROH for a headphone. The headphone amplifier 110 is an adjustable gain stereo amplifier, the gain is set by a signal GD[1:J]. The headphone-out signals LOH and ROH can directly drive a headphone with low-impedance without an external amplifier component, which accordingly saves the fabrication cost.

If the Δ-Σ DACs 106 and 107 have an excellent output quality, the step of filtering high-frequency noise is not needed and the LPFs 108 and 109 can be saved. In the case, the Δ-Σ DAC 106 would directly output the left channel line-out signal LO, while the Δ-Σ DAC 107 would directly output the right channel line-out signal RO. In addition, if a headphone output is not needed, the headphone amplifier 110 can be saved.

The clock signals Fs, Fs_ADC and Fs_DAC are generated by the clock generator 105 in response to a clock signal CK, which has at least two advantages: the synchronization of the clock signals is assured and the clock signal CK provided by an external source can be used to host-control entire recording and playback processes. Since the clock signals Fs, Fs_ADC and Fs_DAC are generated based on the clock signal CK, once the clock signal CK stops, there are no more other clock signals accordingly, and the recording or playback also come to end.

Except for the above-described voice-band audio CODEC apparatus 100, the present invention further provides a voice-recording apparatus, which essentially is a pre-stage audio recording circuit of the voice-band audio CODEC apparatus. Taking the voice-band audio CODEC apparatus 100 in FIG. 1 as an example, the corresponding voice-recording apparatus is formed by the multiplexer 101, the programmable gain amplifier (PGA) 102, the successive approximation analog-to-digital converter (SAR-ADC) 103, the pulse code modulation code digital circuit 104 and the clock signal generator 105. The recording scheme of the above-described voice-recording apparatus is the same as the voice-band audio CODEC apparatus 100, hence it is omitted to describe for simplicity.

In summary, both the voice-band audio CODEC apparatus and the voice-recording apparatus provided by the present invention employ a single SAR-ADC to perform stereo voice recording. In comparison with the prior art where two Δ-Σ ADCs are employed to achieve the stereo voice recording function, the present invention is superior in lower power-consumption and smaller chip area.

In addition, the present invention is able to integrate the programmable gain amplifier (PGA) into the voice-recording apparatus or the pre-stage audio recording circuit of the voice-band audio CODEC apparatus for saving fabrication cost. Furthermore, the present invention is able to integrate the headphone amplifier into the rear-stage playback circuit of the voice-band audio CODEC apparatus, so that no more an external amplifier component is needed, which further saves the fabrication cost.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A voice-recording apparatus, comprising:
a multiplexer, alternatively outputting a left channel input signal and a right channel input signal in response to a first clock signal; and
a successive approximation analog-to-digital converter (SAR-ADC), coupled to the multiplexer, taking a second clock signal as an operation frequency and converting the left channel input signal and the right channel input signal from an analog signal format into a digital signal format.

2. The voice-recording apparatus as recited in claim 1, wherein the frequency of the second clock signal is greater than or equal to a product of a frequency of the first clock signal and 2N, wherein N is the cycle number of the second clock signal required by the SAR-ADC for processing a piece of data.

3. The voice-recording apparatus as recited in claim 1, wherein if the first clock signal is logic-0, the multiplexer outputs the left channel input signal; if the first clock signal is logic-1, the multiplexer outputs the right channel input signal.

4. The voice-recording apparatus as recited in claim 1, wherein if the first clock signal is logic-1, the multiplexer outputs the left channel input signal; if the first clock signal is logic-0, the multiplexer outputs the right channel input signal.

5. The voice-recording apparatus as recited in claim 1, further comprising:
a programmable gain amplifier (PGA), amplifying the output signal from the multiplexer and providing an amplified signal to the SAR-ADC.

6. The voice-recording apparatus as recited in claim 1, further comprising:
a pulse code modulation (PCM) code digital circuit, converting the output signal of the SAR-ADC from a serial digital code to a parallel digital code.

7. The voice-recording apparatus as recited in claim 1, further comprising:
a clock generator, generating the first clock signal and the second clock signal in response to a third clock signal.

8. A voice-band audio CODEC apparatus, comprising:
a multiplexer, alternatively outputting a left channel input signal and a right channel input signal in response to a first clock signal;
a successive approximation analog-to-digital converter (SAR-ADC), coupled to the multiplexer, taking a second clock signal as an operation frequency and converting the left channel input signal and the right channel input signal from an analog signal format into a digital signal format;
a pulse code modulation (PCM) code digital circuit, during recording, to convert the output signal of the SAR-ADC from a serial digital code to a first parallel digital code; and during playback, via an oversampling digital filter to filter and oversample on a second parallel digital code signal for separating into a left channel digital data and a right channel digital data;
a first delta-sigma digital-to-analog converter (first Δ-Σ DAC), according to a third clock signal as the operating frequency, converting the left channel digital data output of the PCM code digital circuit from a digital signal format into an analog signal format; and
a second delta-sigma digital-to-analog converter (second Δ-Σ DAC), according to the third clock signal as the operating frequency, converting the right channel digital data output of the PCM code digital circuit from a digital signal format into an analog signal format.

9. The voice-band audio CODEC apparatus as recited in claim 8, wherein the frequency of the second clock signal is greater than or equal to a product of a frequency of the first clock signal and 2N, wherein N is the cycle number of the second clock signal required by the SAR-ADC for processing a piece of data.

10. The voice-band audio CODEC apparatus as recited in claim 8, wherein if the first clock signal is logic-0, the multiplexer outputs the left channel input signal; if the first clock signal is logic-1, the multiplexer outputs the right channel input signal.

11. The voice-band audio CODEC apparatus as recited in claim 8, wherein if the first clock signal is logic-1, the multiplexer outputs the left channel input signal; if the first clock signal is logic-0, the multiplexer outputs the right channel input signal.

12. The voice-band audio CODEC apparatus as recited in claim 8, further comprising:
a programmable gain amplifier (PGA), amplifying the output signal from the multiplexer and providing an amplified signal to the SAR-ADC.

13. The voice-band audio CODEC apparatus as recited in claim 8, further comprising:
a clock signal generator, generating the first clock signal, the second clock signal and the third clock signal in response to a fourth clock signal.

14. The voice-band audio CODEC apparatus as recited in claim 8, further comprising:
a first low pass filter (first LPF), filtering a high-frequency noise in the output signals from the first Δ-Σ DAC; and
a second low pass filter (second LPF), filtering a high-frequency noise in the output signals from the second Δ-Σ DAC.

15. The voice-band audio CODEC apparatus as recited in claim 14, further comprising:
a headphone amplifier, amplifying the output signals from the first LPF and the second LPF for a headphone to receive.
